(19) United States
(12) Patent Application Publication
(10) Pub. No.: US 2007/0208891 A1
(43) Pub. Date: Sep. 6, 2007

(54) KVM switching system

(75) Inventor: Chien-Hsing Liu, Taipei Hsien (TW)

Correspondence Address: BIRCH STEWART KOLASCH & BIRCH, PO BOX 747, FALLS CHURCH, VA, 22040-0747, US

(73) Assignee: ATEN INTERNATIONAL CO., LTD

(21) Appl. No.: 11/364,339

(22) Filed: Mar. 1, 2006

(51) Int. Cl. G06F 13/38

(52) U.S. Cl. 710/62

(57) ABSTRACT

The present invention provides a KVM switching system including a KVM controller, a signal converter, a processor and a linking apparatus. The booting status signal of a computer is sent to the signal converter, which then converts the status signal. The converted status signal is sent to the processor, which then determines whether or not the computer is in a process of asking a user to enter BIOS setting mode. The processor automatically controls the KVM controller to issue an interruption instruction to the computer when the computer is in the process of asking a user to enter BIOS setting mode.

### FIELD OF THE INVENTION

The present invention relates to a KVM system, and more particularly, to a network KVM system.

### BACKGROUND OF THE INVENTION

The exponential growth of computer systems and network software allow people to utilize networks to search for and gather information from other computers. Conventionally, control of each computer required a monitor, a keyboard and a mouse. That is, each computer needed at least a monitor, a keyboard and a mouse. Such structure resulted in high operation costs and wasted resources. A KVM (keyboard, video monitor and mouse) switch has been used to resolve this expense.

An example of the traditional KVM switch is shown in FIG. 1. A KVM switch 100 can connect to and switch between a plurality of computers 101, 102 and 103 through a network 104. The network 104, such as a LAN, WAN, or Network, provides a communication path for a second computer 105 and computers 101, 102 and 103. Through the switching of the KVM switch 100, the keyboard 106, the monitor 109 and the mouse 107 of the second computer 105 can control these computers 101, 102 and 103. Therefore, the quantities of the peripheral devices can be reduced.

However, the great bandwidth necessary for large networks cannot often be provided, delaying response between computers 101, 102 and 103 and second computer 105. For example, when a computer is booting up, it pauses briefly in case a user desires to access the BIOS setting mode.

Conventionally, only a few seconds are set in the computer 101 to wait for an interruption instruction from a user near the computer 101 or the second computer 105 to access the BIOS setting mode. When the Network connection lags, an interruption instruction does not reach the computer 101 within those few seconds. Such delayed response causes great inconvenience for maintenance staffs.

Moreover, when the computer is broken during booting and no any error information is shown in the display of the computer 105, the remote maintenance staff cannot understand the real reason of the computer broken through the conventional IKVM technology. Therefore, a replacement component may not be prepared in advance by the remote maintenance staff. That is that the remote maintenance staff has to see the computer on the spot to find which component should be replaced first. Then, the maintenance staff goes back to his maintenance office again to prepare this replacement component, which will consume a lot of time.

Therefore, a KVM switch of new design that can resolve the foregoing problems is required.

### SUMMARY OF THE INVENTION

Therefore, it is the purpose of the present invention to provide a KVM switch that is preset as a second computer to control the first computer to enter a BIOS setting mode.

Another purpose of the present invention is to provide a KVM switch that can monitor a remote computer and send the monitored result to a maintenance staff in real time through the network.

According to a preferred embodiment, the present invention provides a KVM switching system includes a KVM controller, a signal converter, a processor and a linking apparatus. The booting status signal from the I/O port 80 of a computer is sent to the signal converter, which converts the status signal to a signal that can be recognized by the KVM switch. The converted status signal is sent to the processor, which determines whether or not the first computer is in the process of asking the user to enter the BIOS setting mode based on the converted status signal. When the processor determines that the first control is in this ask period, the processor automatically controls the KVM controller to issue an interruption instruction to the computer when the computer is in a booting status. The KVM switching system further comprises a memory to store the processed or processing data.

In an embodiment, when the status value of the I/O port 80 is 33 H, 6 FH, 75 H or 7 FH, the processor automatically controls the KVM controller to issue an interruption instruction to the computer to interrupt the booting process and access the BIOS setting mode.

In an embodiment, the interruption instruction is a “DEL” keyboard signal.

According to another embodiment, a first computer is controlled by a second computer through a KVM switching system of the present invention. A converter apparatus is installed in the first computer to convert a status signal value of the first computer. An interface apparatus in the KVM switching system receives the converted status signal value and determines whether or not the first computer is in a booting status. The KVM switching system automatically issues an interruption instruction to the first computer when the first computer is in a booting status. The interface apparatus can be a UART port, a USB port, a parallel port, an IrDA port, a 1394 port, or a Bluetooth port.

According to another embodiment, the present invention provides a method of a KVM switch to control a computer to enter a BIOS setting mode. When a computer is powered, the KVM switch of the present invention may monitor this computer to determine the computer whether or not is questioning the users to enter the BIOS setting mode. When the computer is in this questioning process, an interruption instruction is issued by the KVM switch to this computer to enter the BIOS setting mode.

Accordingly, the present invention provides a KVM switch that can monitor the booting status value from the 1/O port 80 of the first computer and automatically sends out an interruption instruction to interrupt the first computer when the first computer is in a booting state. Therefore, even when the network connection lags, the first computer can still be accessed properly in real time.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 illustrates a schematic diagram of a typical network system using a KVM system;

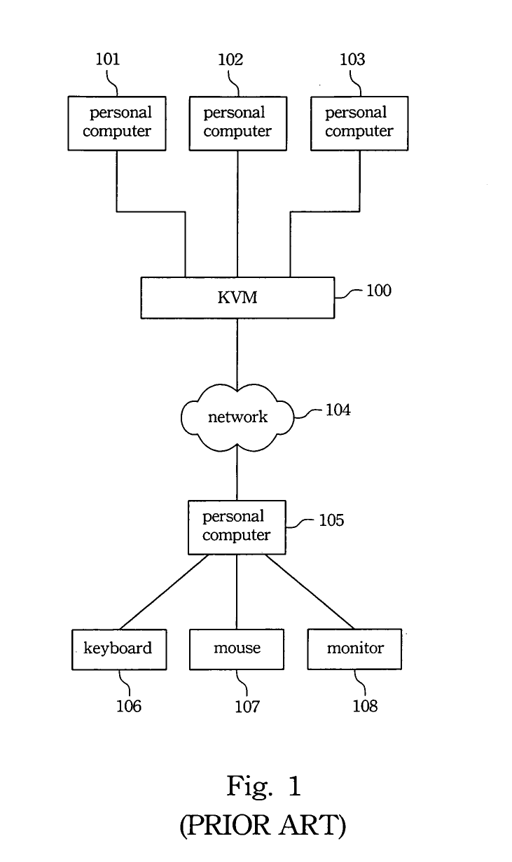

FIG. 2 illustrates a schematic diagram of a KVM switch according to a preferred embodiment of the present invention;

FIG. 3 illustrates a schematic diagram of a KVM switch according to another preferred embodiment of the present invention;

FIG. 4 illustrates a flowchart of the present invention;

FIG. 5 illustrates a schematic diagram of a KVM switch according to another preferred embodiment of the present invention; and

FIG. 6 illustrates a schematic diagram of a KVM switch according to another preferred embodiment of the present invention.

### DETAILED DESCRIPTION OF THE PREFERRED EMBODIMENT

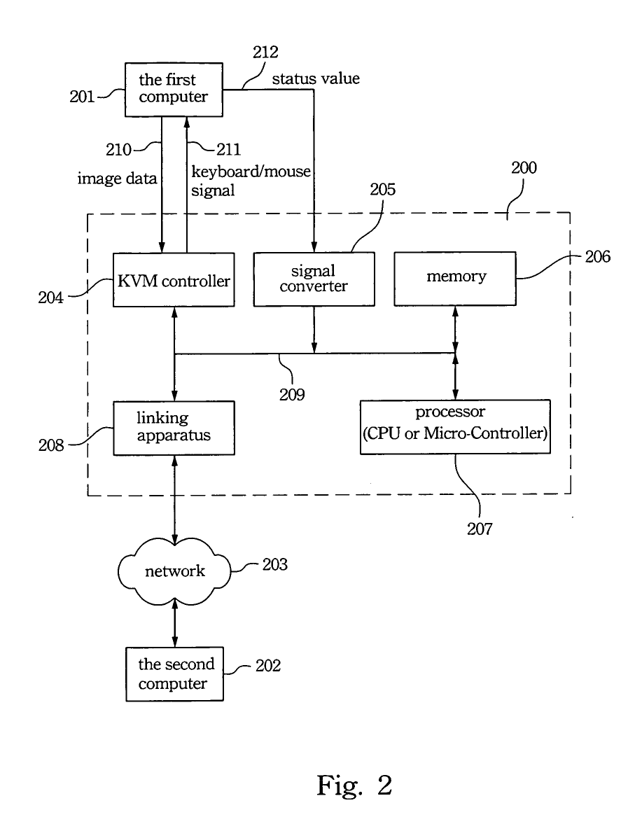

FIG. 2 is a schematic diagram of a KVM switch 200 according to a preferred embodiment of the present invention. The KVM switch 200 of the present invention can connect to a plurality of first computers and switch one of these first computers to connect with the second computer 202 via the network 203. The KVM switch 200 communicates with a second computer 202 through the network 203, such as a LAN, a WAN or the Internet. In FIG. 2, the first computer 201 is switched to connect with the second computer 202 through KVM switch 200. The keyboard, the monitor and the mouse, not shown in FIG. 2, of the second computer 202 can control the first computer 201 through the KVM switch 200. For example, in an embodiment, when the first computer 201 is selected, the image data 210 from the selected first computer 201 is sent to the second computer 202 through the KVM switch 200 and is displayed by the second computer 202. Therefore, a user can see this image in the second computer 202 and, according to the image, send a corresponding keyboard/mouse signal 211 to control the first computer 201.

Please note that the present invention is not limited to an external KVM switch. The present invention also can be implemented by an add-in card inserted into a proper slot, such as LPC, PCI or ISA and the like, of the first computer 201. In other words, the KVM switch 200 of the present invention can be integrated into one card. Then, this card is installed into the first computer 201.

The KVM switch 200 or the add-in card 200 of the present invention includes a KVM controller 204, a signal converter 205, a memory 206, a processor 207 and a linking apparatus 208. The foregoing devices are together connected to a bus 209. The linking apparatus 208 can be a network apparatus for connecting with the network 203, or can be RS-232 or RS-485 interface for providing an access interface for the KVM switch 200. Please note that the KVM controller 207 can be a separate keyboard/mouse controller and a separate video controller. Alternatively, the KVM controller 207 can be an integrated keyboard/video/mouse controller

The KVM switch 200 is connected to the network 203 through the linking apparatus 208 to communicate with the second computer 202. The second computer 202 can issue an instruction, such as a switch instruction, to the KVM switch 200 through the network 208. After the processor 207 receives the switch instruction from the second computer, the processor 207 controls the KVM controller 204 to switch the communication to a selected computer. In this embodiment, the first computer 201 is selected. Additionally, a memory 206 is used as a buffer to store the processed or processing data. Please note that the KVM controller 207 can be a separate keyboard/mouse controller and a separate video controller. Alternatively, the KVM controller 207 can be an integrated keyboard/video/mouse controller.

For preventing a poor network connection from delaying the entering BIOS setting mode instruction of the second computer 202 to the first computer 201, the KVM switch 200 can represent the second computer 202 to issue an entering BIOS setting mode instruction to the first computer 201. In other words, when the first computer 201 is booting and this booting status is detected by the KVM switch 200, the KVM switch 200 can represent the second computer 202 to issue an entering BIOS setting mode instruction to the first computer 201 to force the first computer 201 to enter the setting mode. Therefore, even though a poor network connection happens, the first computer 201 may still enter the BIOS setting mode in time in the present invention.

For example, in an embodiment, the KVM switch 200 can monitor the booting status from the I/O port 80 of the first computer 201. The status signal 212 from the I/O port 80 of the first computer 201 is sent to the signal converter 205, which converts the status signal, such as a LPC/PCI/ISA bus signal, to a format that can be recognized by the KVM switch 200.

The converted status signal is sent to the processor 207 through the bus 209. After the processor 207 receives the converted status signal, the processor 207 can determine whether or not the first computer 201 is in a booting status, that is, whether or not the status value of the I/O port 80 is 33 H or 75 H. The status value of 33 H means to reset keyboard except Winbond 977 series Super I/O chips. The status value of 75 H means to detect and install all IDE devices. When the status value of the I/O port 80 is one of the 33 H and 75 H, the KVM switch 200 may represent the second computer 202 to issue an interruption instruction, such as a “DEL” keyboard signal, to the first computer 201 to interrupt the booting process and let the first computer 201 enter the BIOS setting mode. It is noticed that different computer companies have different rules to define status value. That is different values, BIOS POST codes, may represent a same computer status in different companies. Reference 1 discloses the definition of BIOS POST codes of different companies respectively. However, by the method of extracting and determining the represent meaning of the status value disclosed in the present invention, a computer can be interrupted in real time to enter the BIOS setting mode.

For example, once this selected computer is booting, that is, the status value of 33 H or 75 H is detected by the KVM switch 200, the KVM switch 200 may represent the second computer 202 to send an interruption instruction, such as a “DEL” keyboard signal, to the selected computer to interrupt the booting process and access the first computer 201 in the BIOS setting mode. At this time, even though a poor network connection situation happens, the BIOS setting mode still may be accessed by the second computer 202. Therefore, a maintenance staff may know the BIOS setting mode data through the remotely second computer 202.

On the other hand, a maintenance staff may know the POST status of the first computer 201 through the remote second computer 202 to determine whether or not the first computer 201 is in an abnormal situation.

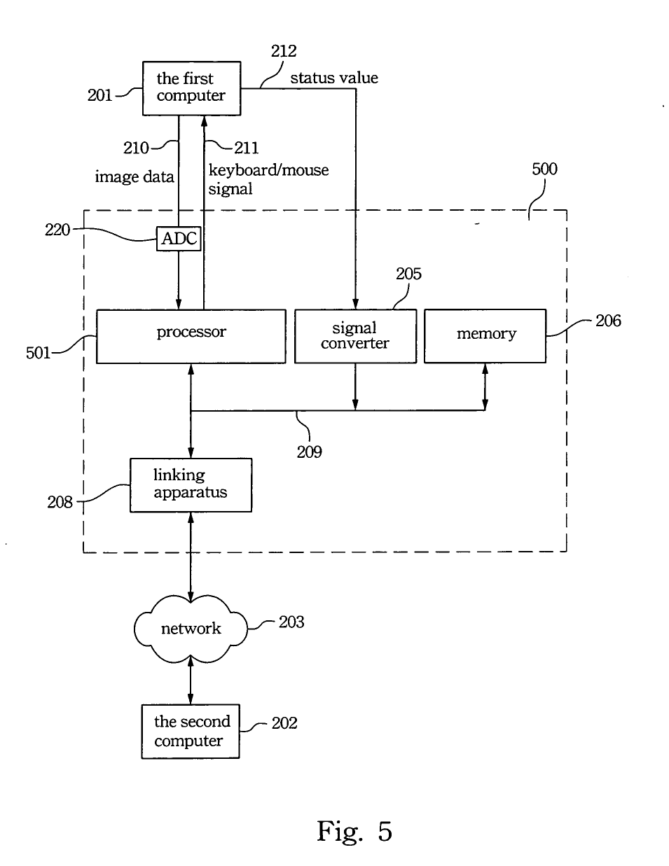

Please refer to FIG. 5, in this embodiment, the present KVM switch 500 includes a processor 501, a signal converter 205, a memory 206, a linking apparatus 208 and analog-to-digital converter(ADC) 220. The processor 501 replaces the above-mentioned KVM controller shown in FIG. 2. Meanwhile, the analog-to-digital converter (ADC) 220 is interposed between the first computer 201 and the processor 501 for processing the image data 210. The signal converter 205, the memory 206 and the linking apparatus 208 have the similar functions, respectively, and cooperate with the processor 501 in the similar way mentioned before. This processor 501 can be a X86 processor, 8051 series processor or the like. The ADC 220 can be AD 9883 offered by Analog Devices. Once the processor 501 determines the first computer 201 is in a process of asking a user to enter BIOS setting mode, an interruption instruction is sent to the first computer 201 by the processor 501.

When the maintenance staff finds the first computer 201 is abnormal, the maintenance staff can prepare a replacement component before he go to fix the first computer 201 and bring the replacement component with him or her.

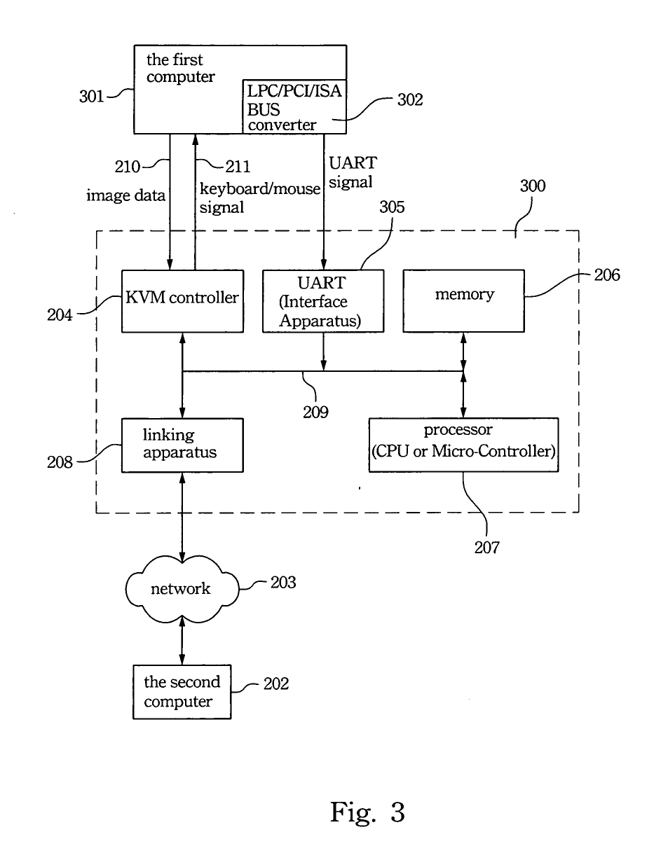

FIG. 3 is a schematic diagram of a KVM switch according to another preferred embodiment of the present invention. According to this embodiment, the first computer 301 is switched to connect with the second computer 202 through the KVM switch 300. The keyboard, the monitor and the mouse, not shown in FIG. 3, of the second computer 202 can control the first computer 301 through the KVM switch 300. A LPC/PCI/ISA bus converter apparatus 302 is installed in the first computer 301. This bus converter 302 is used to extract and transfer the booting status signal value from the first computer 301, such as the I/O port 80 of the first computer 301, to the KVM switch 300.

In a preferred embodiment, the status signal value is transferred to a UART signal. Therefore, an interface apparatus, UART 305, is installed in the KVM switch 300 to receive the UART signal. This UART signal is sent to the processor 207 through the bus 209. After the processor 207 receives the status signal, the processor 207 can determine whether or not the first computer 201 is in the process of asking the user to enter the BIOS setting mode, that is, whether or not the status value of the I/O port 80 is 33 H or 75 H. When the status value of the I/O port 80 is one of the 33 H and 75 H, the KVM switch 300 may replace the first computer 301 to issue an entering BIOS setting mode instruction, such as a “DEL” keyboard signal, to the first computer 201 to interrupt the booting process and access the BIOS setting mode. It is noticed that in other embodiments, the status signal is also transferred to another signal type, such as a USB, a parallel port, an IrDA, a 1394, or a Bluetooth signal type. In these embodiments, a corresponding interface apparatus is installed in the KVM switch 300 according to the interface signal. In other words, the interface apparatus can be a UART port, a USB port, a parallel port, an IrDA port, a 1394 port, or a Bluetooth port.

Similarly, a maintenance staff may know the BIOS setting mode data through the remotely second computer 302 to determine whether or not the first computer 301 is in an abnormal situation. When the maintenance staff find the first computer 301 is in an abnormal, the maintenance staff can prepare a replacement component before he fix the first computer 301, which can very save the time.

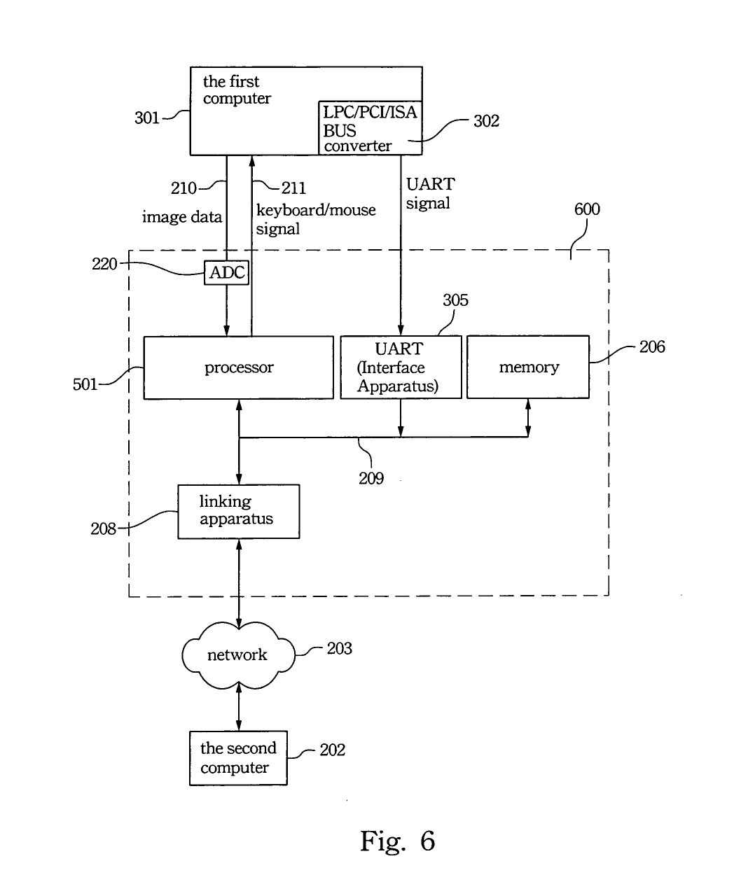

Please refer to FIG. 6, in this embodiment, the present KVM switch 600 includes a processor 501, a signal converter 205, a memory 206, a linking apparatus 208, a bus converter 302, analog-to-digital converter(ADC) 220 and an Interface apparatus, UART 305. The processor 501 replaces the above-mentioned KVM controller 501 shown in FIG. 3. Meanwhile, the analog-to-digital converter(ADC) 220 is interposed between the first computer 301 and the processor 501 for processing the image data 210. The signal converter 205, the memory 206, the UART 305, the bus converter 302 and the linking apparatus 208 have the similar functions, respectively, and cooperate with the processor 270 in the similar way mentioned before. This processor 501 can be a X86 processor, 8051 series processor or the like. The ADC 220 can be AD 9883 offered by Analog Devices. Once the processor 501 determines the first computer 201 is in a process of asking a user to enter BIOS setting mode, an interruption instruction is sent to the first computer 201 by the processor 501. It is noticed that in other embodiments, the status signal is also transferred to another signal type, such as a USB, a parallel port, an IrDA, a 1394, or a Bluetooth signal type. In these embodiments, a corresponding interface apparatus is installed in the KVM switch 300 according to the interface signal type. In other words, the interface apparatus can be a UART port, a USB port, a parallel port, an IrDA port, a 1394 port, or a Bluetooth port.

Accordingly, the present invention provides a KVM switch that can monitor the booting status value in the I/O port 80 of the first computer and automatically sends out an interruption instruction to interrupt the first computer when the first computer is in a booting state. Therefore, even when the network connection lags, the first computer is also switched to the BIOS setting mode in real time. Therefore, a remote maintenance staff can view the BIOS setting mode to determine whether or not the first computer is in an abnormal situation. In other words, by real time switching to the BIOS setting mode, the power-on self-test destination can be reached.

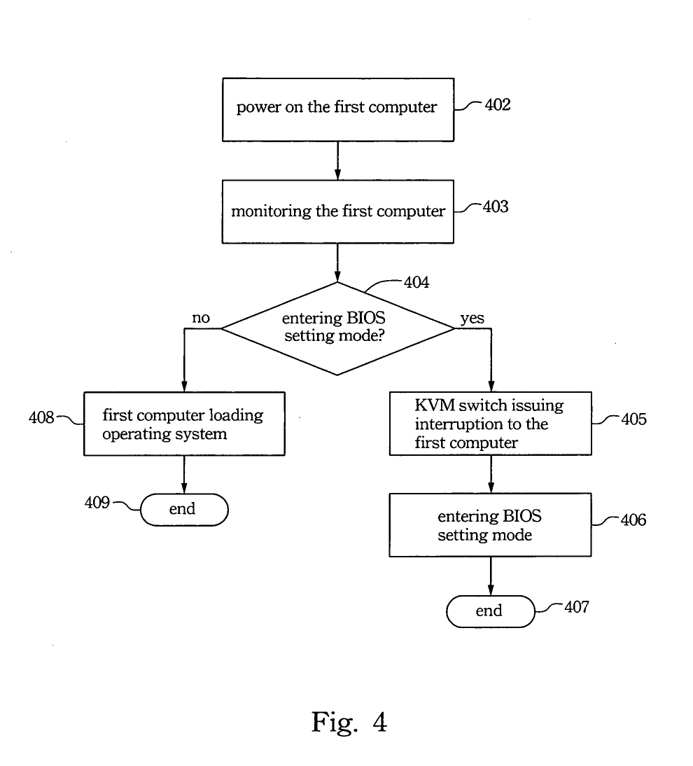

FIG. 4 illustrates a flowchart of the present invention. Please also refer to FIG. 2. First, in step 402, the first computer 201 is powered on. In step 403, the KVM switch 200 may monitor the status of the first computer 201. That is a converter 205 may converted a booting signal from the first computer 201. Then, the processor 207 of the KVM switch 200 may determine the first computer 201 whether or not is in this process of questioning the user to enter the BIOS setting mode based on the converted status value. For example, in an embodiment, the KVM switch 200 may monitor the I/O port of the first computer 201 to determine the status value of the I/O port 80 whether or not is 33 H or 75 H. According to the present invention, for preventing a poor network connection from delaying the entering BIOS setting mode instruction of the second computer 202 to the first computer 201, the KVM switch 200 may represent the second computer 202 to issue instruction to control the first computer. Therefore, in step 404, a determination step of whether or not entering BIOS setting mode step is performed. That is when the function of entering BIOS setting mode of the KVM switch 200 is set, the KVM switch 200 may represent the second computer 202 to issue an entering BIOS setting mode instruction to the first computer 201 in step 405. Then, the first computer 201 enters the BIOS setting mode in step 406. Then, this process is ended in step 407. On the other hand, when the function of entering BIOS setting mode of the KVM switch 200 is not set and the second computer also does not issue an entering BIOS setting mode instruction, the first computer 201 may perform the normal process to load the operating system in step 408.Then, this process is ended in step 409.

As is understood by a person skilled in the art, the foregoing descriptions of the preferred embodiments of the present invention are illustrations of the present invention rather than limitations thereof. Various modifications and similar arrangements are included within the spirit and scope of the appended claims. The scope of the claims should be accorded to the broadest interpretation so as to encompass all such modifications and similar structures. While preferred embodiments of the invention have been illustrated and described, it will be appreciated that various changes can be made therein without departing from the spirit and scope of the invention.

What is claimed is:

1. A KVM switching system coupling at least one first computer to a second computer, said system comprising:
a signal converter for monitoring and converting a status value of said controlled computer; and
a processor for receiving said converted status value and determining whether or not said first computer is in a process of asking a user to enter BIOS setting mode according to said converted status value, and when said first computer is in said process of asking a user to enter BIOS setting mode, issuing an interruption instruction to said first computer to make said first computer enter BIOS setting mode.

2. The KVM switching system of claim 1, wherein said interruption instruction is a keyboard signal.

3. The KVM switching system of claim 3, wherein said keyboard signal is the “DEL” key value.

4. The KVM switching system of claim 1, wherein said status value is 33 H or 75 H.

5. The KVM switching system of claim 1, further comprises a linking apparatus for coupling the first computers to the second computer.

6. The KVM switching system of claim 1, wherein the second computer is coupled to the first computer through a network.

7. The KVM switching system of claim 6, wherein said system further comprises a memory used a to store the processed or processing data.

8. The KVM switching system of claim 1, wherein said status value is extracted from I/O port 80 of the second computer.

9. A KVM switching system with a linking apparatus to connect with a network for coupling with at least one first computer and a second computer, wherein each of said first computers has a converter apparatus for converting a status value of the plurality of first computers, said system comprising:
a KVM controller for selecting one of said first computers as a controlled computer;
an interface apparatus coupled with the converter apparatus of said first computer for receiving said converted status value; and
a processor for receiving said converted status value and determining whether or not said first computer is in a process of asking a user to enter BIOS setting mode according to said converted status value, and when said first computer is in said process of asking a user to enter BIOS setting mode, said KVM controller issuing an interruption instruction to said controlled computer.

10. The KVM switching system of claim 9, wherein said system further comprises a memory to store a processed or processing data.

11. The KVM switching system of claim 9, wherein said interruption instruction is a keyboard signal.

12. The KVM switching system of claim 11, wherein said keyboard signal is the “DEL” key value.

13. The KVM switching system of claim 9, wherein said status value is 33 H or 75 H.

14. The KVM switching system of claim 9, wherein said interface apparatus is a UART port, a USB port, a parallel port, an IrDA port, a 1394 port, or a Bluetooth port.

15. The KVM switching system of claim 9, wherein said network is a LAN, a WAN or the Network.

16. The KVM switching system of claim 9, wherein said KVM controller, said interface apparatus, said processor and said linking apparatus are together connected to a same bus.

17. The KVM switching system of claim 9, wherein said status value is extracted from I/O port 80.

18. A KVM switching system coupling at least one first computer to a second computer, said system comprising:
a KVM controller for selecting one of said first computers as a controlled computer;
a signal converter for monitoring and converting a status value said controlled computer; and
a processor for receiving said converted status value and determining whether or not said first computer is in a process of asking a user to enter BIOS setting mode according to said converted status value, and when said first computer is in said process of asking a user to enter BIOS setting mode, said KVM controller issuing an interrupt instruction to said first computer to make said first computer enter BIOS setting mode.

19. A method for a KVM switch to control a first computer to enter BIOS setting mode when said first computer is booted, wherein said KVM switch comprises a converter and a processor, said method comprising:
converting a status value form said first computer by said converter; and
receiving said converted status value by said processor for determining whether or not said first computer is in a process of asking a user to enter BIOS setting mode according to said converted status value, and when said first computer is in said process of asking a user to enter BIOS setting mode, said KVM controller issuing an interruption instruction to said first computer to make said first computer enter BIOS setting mode.

20. The method of claim 19, wherein said interruption instruction is a keyboard signal.

21. The method of claim 20, wherein said keyboard signal is the “DEL” key value.

22. The method of claim 19, wherein said status value is 33 H or 75 H.

23. The method of claim 19, wherein said method further comprises using a linking apparatus to connect with a second computer.

24. The KVM switching system of claim 19, wherein said status value is extracted from I/O port 80.
